(19) United States
(12) Patent Application Publication
(10) Pub. No.: US 2010/0277934 A1
(43) Pub. Date: Nov. 4, 2010

(54) RETROFIT KIT AND LIGHT ASSEMBLY FOR TROFFER LIGHTING FIXTURES

(76) Inventors: Saturnino Oquendo, JR., Oviedo, FL (US); Dominick J. Cerce, Lake Mary, FL (US)

Correspondence Address: Michael L. Leetzow, P.A., 2393 Crest Ridge Ct, SANFORD, FL, 32771, US

(21) Appl. No.: 12/772,886

(22) Filed: May 3, 2010

Related U.S. Application Data
(60) Provisional application No. 61/175,247, filed on May 4, 2009.

(51) Int. Cl. F21V 17/06

(52) U.S. Cl. 362/433

(57) ABSTRACT

A retrofit kit and light assembly is provided for retrofitting an existing troffer lighting fixture having four side walls defining a recessed cavity. The retrofit kit comprises a plurality of interlocking frame members, a reflector, and a lens. The plurality of interlocking frame members are configured to interconnect with one another to form a rectangular shell with an open face pointing downwards. The reflector is configured to interconnect with respective ones of the plurality of interlocking frame members and the lens is configured to interconnect with the reflector. Each of the plurality interconnecting frame members comprises a bottom portion and an angled body portion such that the rectangular shell may be formed by the interconnecting frame members and fits within the recessed cavity of the existing troffer lighting fixture when assembled.

This application claims the benefit of application Ser. No. 61/175,247, filed on May 4, 2009, which is hereby incorporated by reference in its entirety.

### BACKGROUND OF THE INVENTION

1. Field of the Invention

The present invention relates to a retrofit kit for troffer lighting fixtures and to a method of upgrading preexisting troffer lighting fixtures using the retrofit kit.

2. Technical Background

Fluorescent lamps have long been used as the primary light source in indoor settings, e.g., large office buildings, since at least about 1951. The light produced by a fluorescent tube is generated by an electric current being conducted through mercury and inert gases. Fluorescent lamps are generally used in indoor applications for both ambient and task lighting because their low brightness creates less direct glare than do incandescent bulbs, and because fluorescent lighting is about three to four times as energy efficient as incandescent lighting. In the past, the fluorescent lamps have been in the form of linear T8 (1 inch diameter) or T12 (1.5 inch diameter) tubes. More recently, however, smaller diameter fluorescent lamps, e.g., the T5 lamp, have become available. The linear T5 (⅝ inch diameter) lamp has a number of advantages over the T8 and T12 lamps. In particular, T5 lamps allow for the configuration of smaller lighting fixtures that provide a high lumen output with fewer lamps, which reduces lamp disposal requirements and has the potential for reducing overall costs. Accordingly, there is a need for retrofit kits, which may allow for the easy and cost-effective retrofitting of T5 lamps in lamp assemblies configured for T8, T12 and other lamps, for example.

Additional features and advantages of the invention will be set forth in the detailed description which follows and, in part, will be readily apparent to those skilled in the art from that description or recognized by practicing the invention as described herein, including the detailed description which follows, the claims, and the appended drawings.

It is to be understood that both the foregoing general description and the following detailed description of the present embodiments of the invention are exemplary and explanatory, and are intended to provide an overview or framework for understanding the nature and character of the invention as it is claimed. The accompanying drawings are included to provide a further understanding of the invention and are incorporated into and constitute a part of this specification. The drawings illustrate various embodiments of the invention and, together with the description, serve to explain the principles and operations of the invention.

### BRIEF DESCRIPTION OF THE DRAWINGS

FIG. 1 is a perspective view of a first embodiment of a retrofit kit according to the present invention;

FIG. 2 is a perspective view of the retrofit kit of FIG. 1 in an assembled state;

FIG. 3 is an exploded top perspective view of a second embodiment of a retrofit kit according to the present invention;

FIG. 4 is a bottom perspective view of the retrofit kit of FIG. 3;

FIG. 5 is a top perspective view of the retrofit kit of FIG. 3;

FIG. 6 is a cross section view of the retrofit kit of FIG. 3 in an assembled state;

FIG. 7 is a partial cross section view of one end of the retrofit kit of FIG. 3 in a fully assembled state;

FIG. 8 is an end view of the retrofit kit of FIG. 6;

FIG. 9 is a side view of the retrofit kit of FIG. 6;

FIG. 10 is a front view of the retrofit kit of FIG. 3 in a partially assembled state;

FIG. 11 is a front view of the retrofit kit of FIG. 6 in a portion of the ceiling;

FIG. 12 is a side view of the retrofit kit of FIG. 11 in the ceiling; and

FIG. 13 is a view of a third embodiment of a retrofit kit according to the present invention.

### DETAILED DESCRIPTION OF THE PREFERRED EMBODIMENTS

Existing troffer lighting fixtures typically comprise a recessed housing defined by at least four sidewalls within which a reflector, lamp sockets, socket brackets, one or more ballast units and/or associated wiring are mounted. Generally, the existing light fixture is affixed to the ceiling over an area to be illuminated by any suitable structure known in the art, such as by fasteners, wire or chain hangers, and the like. Advantageously, embodiments of the retrofit kits of the present invention enable existing lighting fixtures to be modified from a number of different lighting fixture types, e.g., a T-12 lighting fixture, to a second type of lighting fixture, e.g., a T-5 light fixture without the need to remove and replace all the components of the existing troffer lighting fixture. In this way, the present invention offers a fast and quick solution for retrofitting a plurality of different lighting sources to provide a singular uniform lighting source, which is preferably more energy efficient and cost-effective than the existing lighting fixtures.

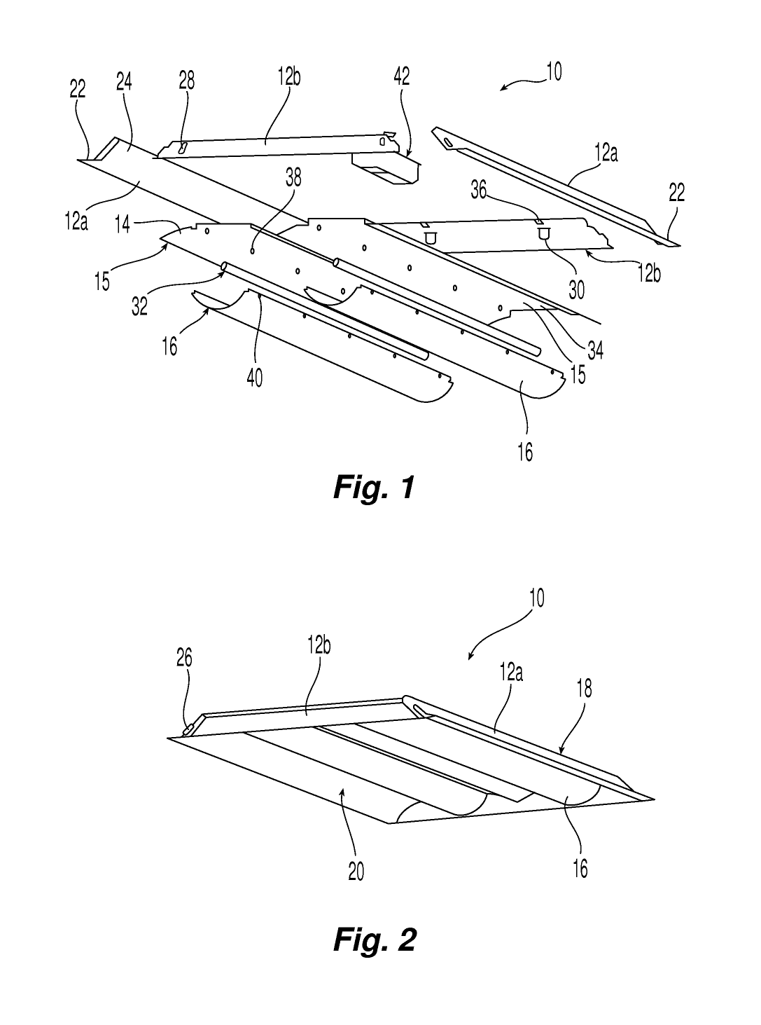

Now referring to the drawings, FIG. 1 is directed to an embodiment of a retrofit kit 10 in accordance with an aspect the present invention and in an unassembled state. The retrofit fit 10 comprises a plurality of interlocking frame members 12, a reflector 14, and lenses 16. The interlocking frame members 12 collectively form a rectangular shell 18 when assembled (see FIG. 2) with an open face 20 pointing downwards from the ceiling when installed. In one embodiment, two of the interlocking frame members 12a each comprise an extent 22, an angled body portion 24 and either a tab 26 or an aperture 28. The extent 22 of each of the side interlocking frame members 12a will abut against either a wall of the recessed cavity of the existing troffer lighting fixture or the front edge thereof when mounted therein to retain all of the interlocking members 12 within the recessed cavity. The angled body portion 24 enables the side interlocking frame members 12a to be secured or interconnected to the side interlocking frame members 12b without interference of any fastening structures and the sidewalls of the recessed cavity. In one embodiment, selected ones of the interlocking frame members 12 will include a tab 26 that is adapted to be inserted into a mating aperture 28 of a selected adjacent one of the interlocking frame members 12. For example, the side interlocking frame members 12a may have the tab 26 and the end interlocking frame members 12b will have the mating aperture 28. In another embodiment, the end interlocking frame members 12b will have the tab 26 and the side interlocking frame members 12a will have the mating aperture. The tab 26 or aperture 28 is typically located on the angled body portion 24 of the side interlocking frame members 12a. Alternatively, any other suitable structure(s) for securing together or interconnecting the frame members 12 may be provided, such as nuts and bolts, and the like.

Once assembled within the existing lighting fixture, the interlocking frame members 12 advantageously fit within the existing housing of an existing troffer light fixture without the need to remove and replace all the components of the existing troffer lighting fixture. For example, only the existing reflector, light source, and ballast (if necessary) may need to be removed. Thereafter, the retrofit kit 10 may be installed on the existing grid of the existing lighting fixture. Moreover, the retrofit kit 10 may be installed without any need for tools once the necessary components of the existing lighting fixture have been removed. Further advantageously, the interlocking frame members 12 are configured to fit within the cavity of the housing of an existing troffer lighting fixture regardless of a depth of the recess of the existing light fixture to accommodate a more efficient lighting system, such as a T-5 lighting system. In this way, the retrofit kit 10 may be installed within a building having several different types of existing lighting fixtures (having different recess depths, for example) to provide a single troffer lighting fixture type with a uniform appearance. For example, the uniform appearance may comprise a uniform depth of the light source within each lighting fixture upgraded with the retrofit kit 10. In this way, a uniform lighting appearance and distribution of light may be provided from each lighting fixture upgraded with the retrofit kit 10.

To install a new light source, a pair of opposed end interlocking frame members 12b include sockets 32 for accommodating a light source, such as T-5 lamps 32 as shown in FIG. 1. The light source may be included with the retrofit kit 10 or may be provided by a third party separately.

The reflector 14 is preferably formed from a single piece of material, e.g., aluminum, having a reflective coating applied to a bottom side thereof. In one embodiment, the reflector 14 is formed from aluminum and may be from 1/32 inch thick to 1/64 inch thick, for example. Holes are optionally provided in the reflector 14 to allow a small amount of light to pass through the reflector 14, to illuminate areas above the reflector 14, and to facilitate convective cooling of the lamps 32 installed below the reflector 14. The reflector 14 typically has a concave shape (with the concave portion facing downward) such that the reflector 14 is able to reflect light in a downward direction from the lamps 32, which will be disposed below the reflector 14 when the reflector 14 and the lamps 32 are installed. In one embodiment, the reflector 14 comprises two bowls 15 as shown in FIGS. 1 and 2. One of the bowls 15 may be disposed on a left side of the rectangular shell 18 while the other of the bowls 15 may be disposed on a right side of the rectangular shell 18 when assembled. Alternatively, any other suitable reflector configuration may be provided.

To facilitate the interlocking of the reflector 14 to the interlocking frame members, the reflector 14 may include apertures 34 that are adapted to mate with respective tabs 36 on an associated interlocking frame member 12a. Once the tabs 36 are inserted within an associated aperture 34, the tabs 36 may be folded down to hold the reflector 14 in place. Alternatively, any other suitable structure for removably or fixedly connecting the reflector 14 to the interconnecting frame members 14 may be provided, such as nuts and bolts, and the like.

Further, to facilitate the interconnection of the lenses 16 with the reflector 14 as set forth below, in one embodiment, the reflector 14 may also itself comprise a plurality of tabs 38 that are adapted to fit within respective apertures 40 in the lenses 16. In another embodiment, the lenses 16 comprise a single extruded piece of flexible material that may be frictionally fit against the reflector 14 and/or the interlocking frame members 32. Optionally, a gasket is provided along an edge of the extruded lens piece to facilitate the frictional fit. Alternatively, any other suitable structure for interconnecting the lenses 16 and the reflector 14 or interconnecting the lenses 16 with the interconnecting frame members 12 may be provided.

The lenses 16 are adapted to further spread the light from the lamps 32 when installed below the lenses 16. In one embodiment, the retrofit kit 10 comprises two lenses 16 as shown, which are each formed from a suitable, relatively transparent material, such as a polymer, e.g., a relatively transparent acrylic polymer or a polycarbonate material. In one embodiment, the lenses 16 may have a substantially flat shape. In addition, the lenses 16 may each have a substantially smooth surface or may comprise prismatic lenses having a plurality of prisms formed on a surface thereof. Preferably, the prisms are located on an inner portion of the lenses 16 to bend light outward as light from the lamps 32.

Optionally, the ballast of the existing troffer lighting fixture may be replaced and rewired prior to installing the retrofit kit 10 as described herein. For example, the ballast of the existing lighting fixture, which may be a T-8 or T-12 lighting fixture, may be removed and a new ballast 42 (see FIG. 1) suitable for the upgraded lighting fixture to be installed, e.g., a T-5 ballast, may be installed. It is understood that a suitable power supply will provide power to the ballast and the lighting assembly.

The assembly of the retrofit kit 10 will be explained in detail again below. To assemble the retrofit kit 10, the existing ballast is removed from an existing troffer lighting fixture (if necessary) and a new ballast 42 is installed and rewired as is known in the art. Thereafter, the interconnecting frame members 12 are interconnected (one at a time) with one another within the recessed cavity of the existing lighting fixture via the mating tabs 26 and apertures 28 (or the like) such that the extents 22 of each of the interconnecting frame members 12 fit against the sidewalls of the existing lighting fixture or the ceiling grid and the rectangular shell 18 is formed. Thereafter, the reflector 14 may be installed by positioning the tabs 36 of the interlocking frame members 12 within respective mating apertures 34 in the reflector 14. Next, the lamps 32, e.g., a pair of T-5 lamps, are installed between two end interlocking frame members 12b via ends of the lamps 32 within corresponding sockets 30 in the end interlocking frame members 12b. Thereafter, the lenses 16 may installed at a lower portion of the recessed cavity by positioning the tabs 38 on the reflector 14 within mating apertures 40 in the lenses 16 to complete the assembly.

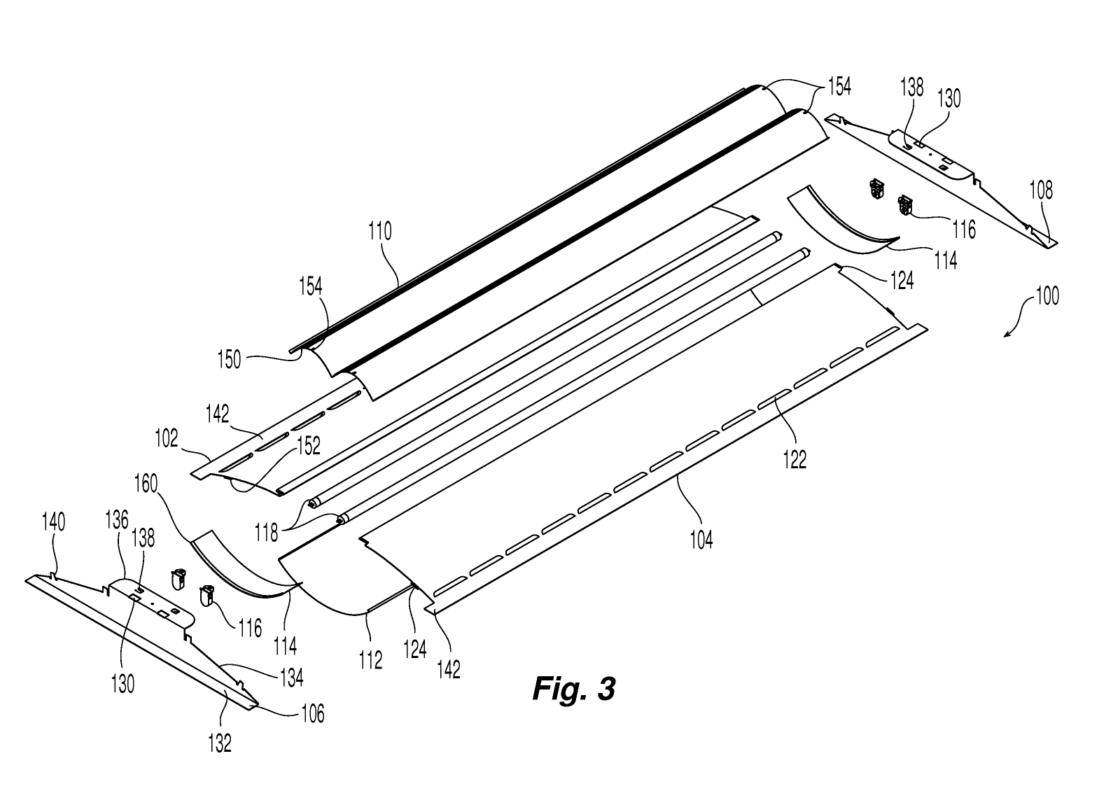

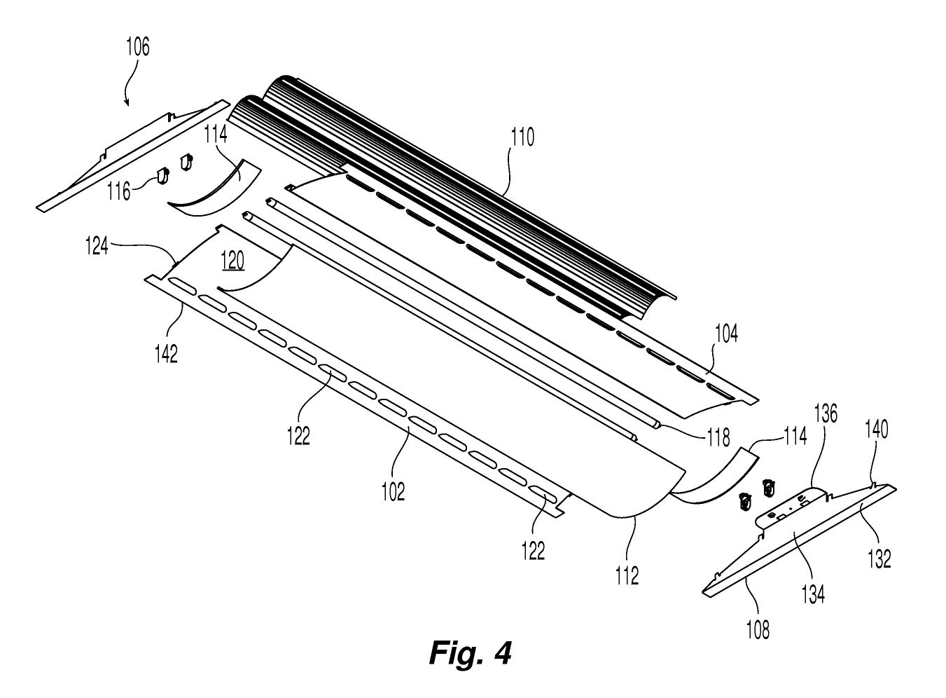

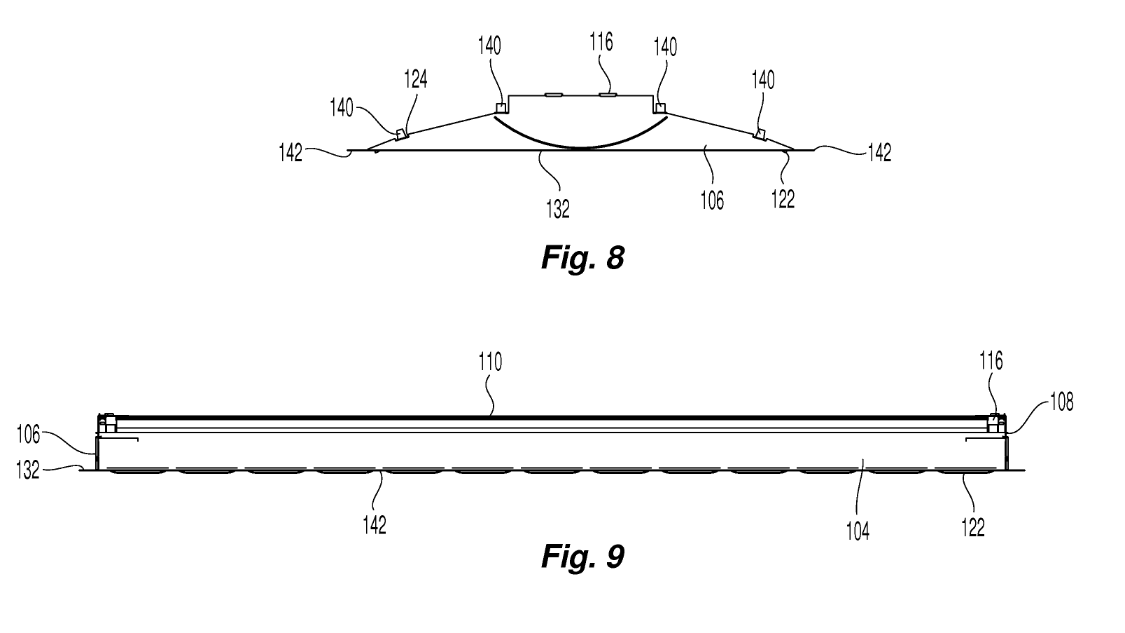

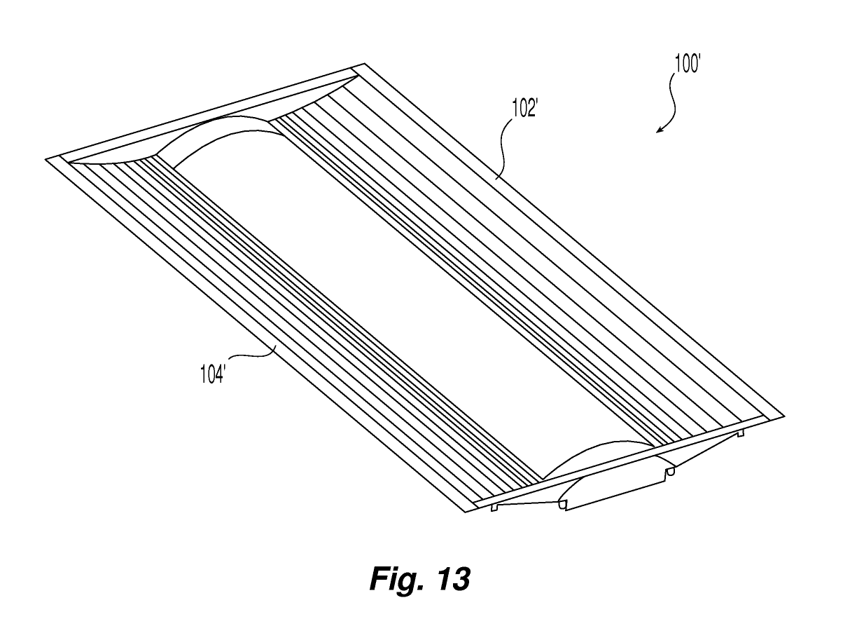

Another embodiment of a retrofit kit 100 according to the present invention is illustrated in FIGS. 3-12. The retrofit kit 100 has a plurality of interlocking frame members 102,104,106,108, a reflector 110, a lens 112, lens covers 114, and sockets 116. The retrofit kit 110 may also include the lamps 118, but they may be provided by the user or another supplier. The side interlocking frame members 102,104 are generally elongated and extend parallel to the lamps 118. The side interlocking frame members 102,104 are generally curved, having a concave shape from the front side of the retrofit kit 100. The front surface 120 of the side interlocking frame members 102, 104 may also be faceted to assist in reflecting light from the lamps 118 downward. See FIG. 13. The side interlocking frame members 102,104 may also include openings 122 to allow for air circulation from the HVAC system. While the openings 122 are illustrated along the outside edge of the side interlocking numbers 102,104, they could be included anywhere on the side interlocking frame members 102,104. As with the above embodiment, the side interlocking frame members 102,104 preferably have apertures 124 used to connect with the end interlocking frame numbers 106,108.

The end interlocking frame members 106,108 connect to the ends of the side interlocking frame members 102,104 and have openings 130 for sockets 116. The end interlocking frame members 106,108 have a first flat surface 132 and a vertical portion 134 extending from one side of the flat surface 132 terminating in a second flat surface 136. Preferably, first flat surface 132 and second flat surface 136 are parallel to one another. As best illustrated in FIG. 3, openings 130 for sockets 116 are preferably disposed in the second flat surface 136. Second flat surface 136 preferably includes tabs 138, which are used to hold reflector 110 within the assembled retrofit kit 100, as described in more detail below. Vertical portion 134 also preferably includes tabs 140 that cooperate with apertures 124 to secure the end interlocking frame members 106, 108 with the side interlocking frame members 102,104. Alternatively, the tabs 140 could be disposed on the side interlocking frame members 102,104 and the apertures 124 could be disposed on the vertical portion 134.

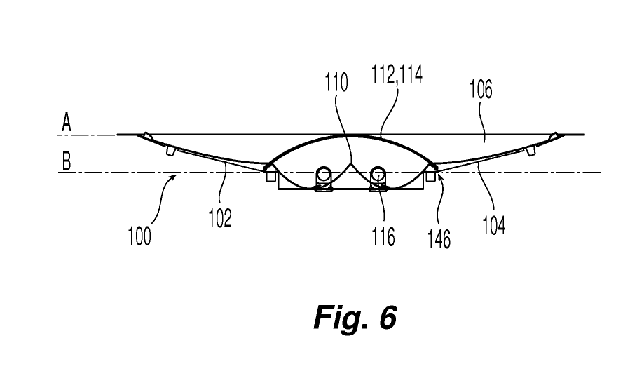

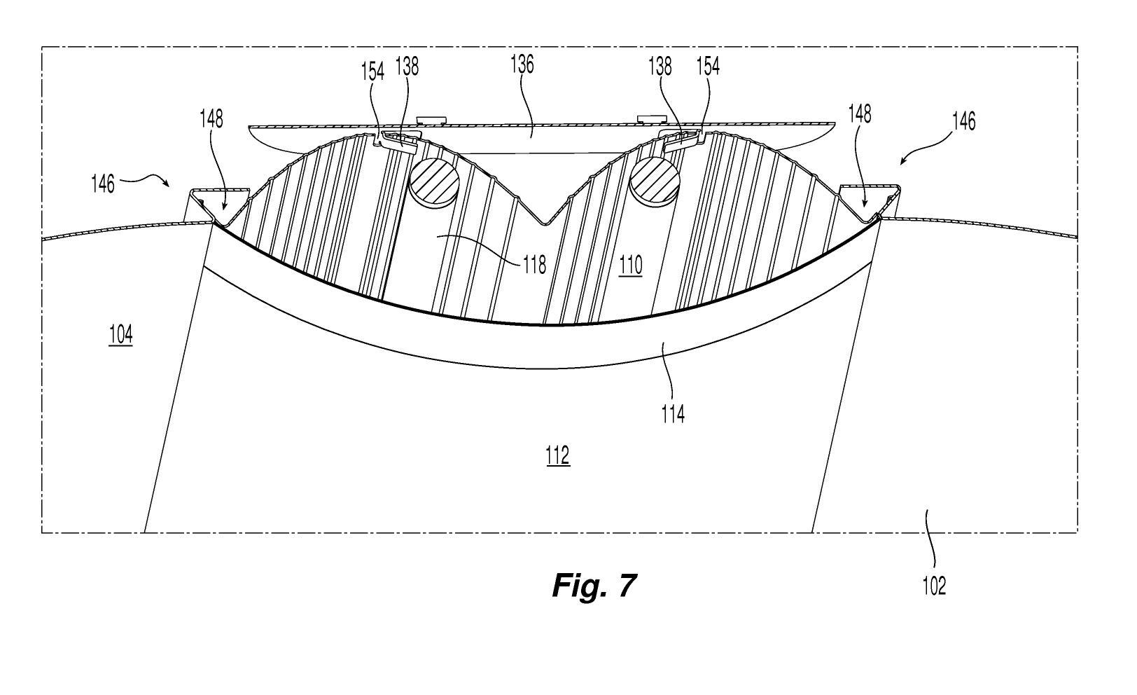

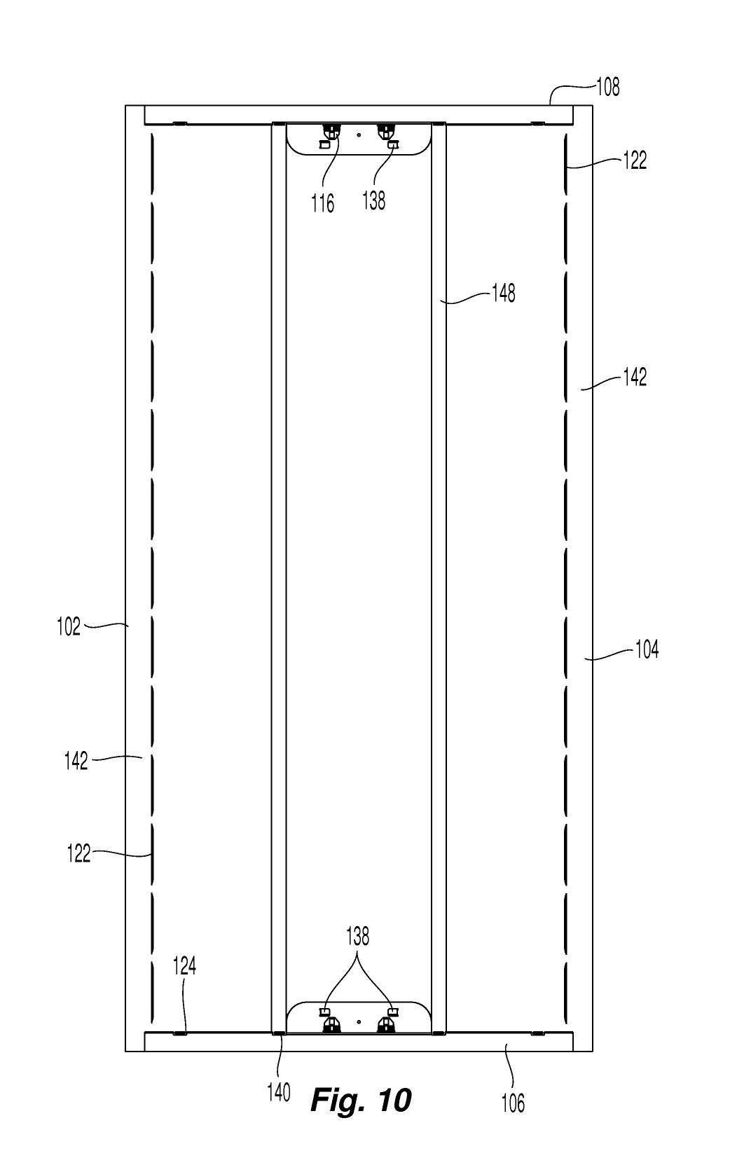

The side interlocking frame members 102,104 have an outside flat surface 142, which when the interlocking frame members 102,104,106,108 are assembled to make a rectangular shell, the first flat surface 132 of the end interlocking frame members 106,108 and the outside flat surfaces 142 (extent in the first embodiment) of these side interlocking frame numbers 102, 104, form a flat surface on which the rectangular shell (see FIG. 10) of the retrofit kit 100 will rest as discussed in more detail below. The side interlocking frame members 102,104 have an inside edge portion 146. The inside edge portion 146 has, as best illustrated in FIGS. 6 and 7, a configuration that is generally z-shaped. More particularly, the inside edge portion 146 has a trough 148 that retains the lens 112, the lens covers 114, and the outside edges of the reflector 110, which will be detailed below.

The reflector 110 preferably extends between the two end interlocking frame members 106,108. In this embodiment, the reflector 110 is configured for two lamps 118, but it could also be configured along with the retrofit kit for just one lamp. The two concave portions 150, 152 are reflective and reflect light from the lamps 118 downward and out of the retrofit kit 100. At each end of the reflector 110, and in each of the two concave portions 150, 152, are two slots or openings 154. The openings 154 meet with and engage the tabs 138 on the second flat surface 136 to hold the reflector 110 within the retrofit kit 100 and relative to the end interlocking frame members 106, 108. The engagement of the openings 154 with the tabs 138 is best illustrated in FIG. 7. The outside elongated edges of the reflector 110 are also disposed within the trough 148 of the inside edge portion 146 of the side interlocking frame numbers 102, 104. See FIGS. 6 and 7.

The lens 112 has, when not installed in the retrofit kit 100, a generally flat configuration. For installation, lens 112 is slightly bowed lengthwise and the elongated edges of the lens 112 are inserted into the trough 148 of the inside edge portion 146 of the side interlocking frame members 102,104. While generally the lens 112 will remain engaged within the trough 148, the lens covers 114 are placed over the lens 112 adjacent the end interlocking frame members 106, 108 to retain the lens 112 within the assembled retrofit kit 100. Preferably, the lens covers 114 are made from a lightweight metallic material preformed in the concave configuration as illustrated in the figures. Elastic material 160 may be applied along one side of the lens covers 114 to engage the end interlocking frame numbers 106,108 to prevent light leakage from the outside edges of the lens covers 114.

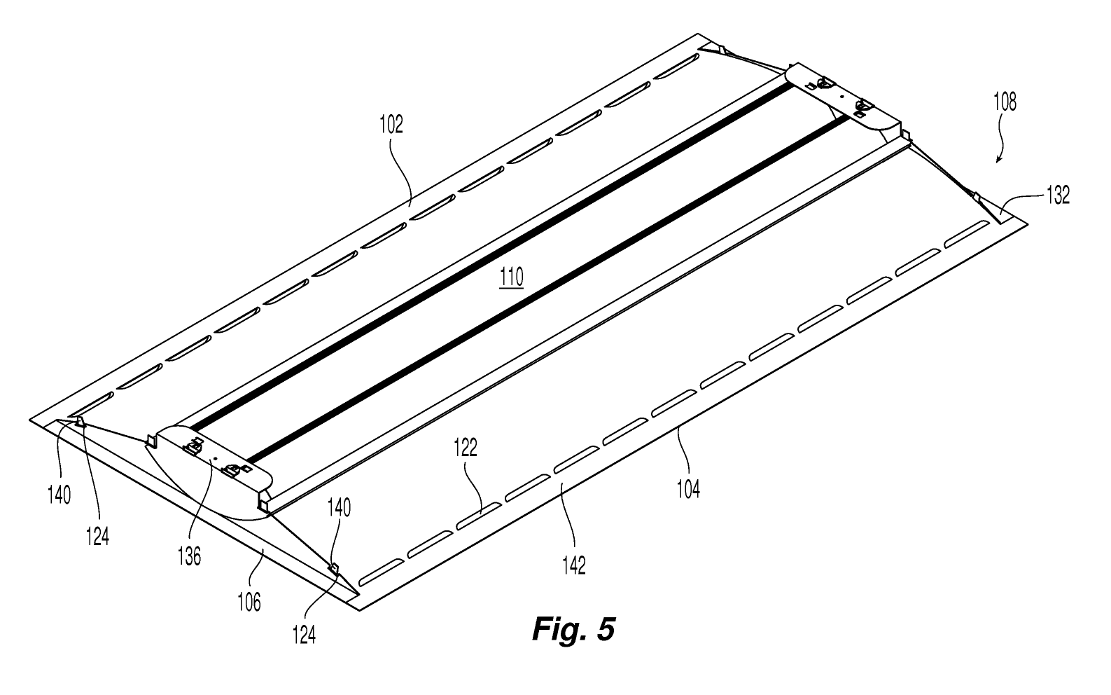

To install the retrofit kit 100 into a ceiling, the components of the old light fixture, except for the existing troffer lighting fixture (the housing), are removed. Any rewiring may then be done. The two end interlocking frame members 106,108 are placed in the opening of the ceiling at either end on the ceiling grid. The sockets 116 would be already installed in the end interlocking frame members 106,108. The first flat surface 132 will lie flush on the ceiling grid. The two side interlocking frame members 102,104 are then inserted into the opening of the ceiling and the apertures 124 are placed over the tabs 140 on the two end interlocking frame members 106, 108. See, e.g., FIGS. 5 and 10. The tabs 140 are then folded over to interlock the end and side interlocking frame members to one another and to create the rectangular shell within the ceiling opening. See FIG. 10. The outside flat surface 142 of the side interlocking frame numbers 102,104 are in the same plane as the first flat surface 132 and will preferably flushingly engage the upper side of the ceiling grid. See, e.g., FIGS. 6 and 11-12.

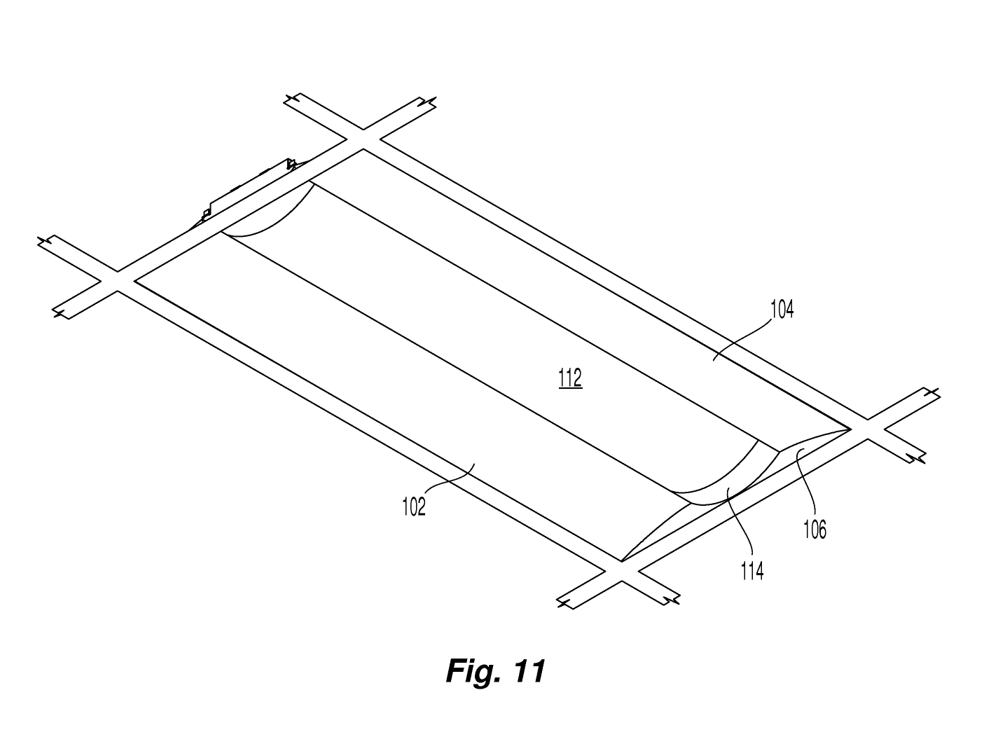

The reflector 110 is then placed adjacent one of the end interlocking frame members 106,108 and preferably squeezed inward from its outer edges at one end to allow the slots 154 to engage the tabs 138. The second end of the reflector 110 is also slightly squeezed inward to allow the slots 154 at the other end of the reflector 110 to engage the tabs 138 on the other of the end interlocking frame member and to also align the outer edges of the reflector 110 with the trough 148 of each of the side interlocking frame members 102, 104. The natural tension of the reflector 110, along with the cooperation of the slots 154 and tabs 138, will keep the reflector 110 engaged in the trough 148. Lamps 118 may then be installed if so desired. The lens 112 is slightly deformed from its generally flat configuration to its curved configuration to also engage the trough 148 of each of the side interlocking frame numbers 102,104. The lens covers 114 can then also be inserted into the trough 148 of each of the side interlocking frame members 102,104 to ensure that the lens 112 remains in place. However, it should be noted that a pre-configured lens may also be utilized and still fall within the scope of the present invention. In this event, the lens covers 114 may or may not be required. See FIG. 11

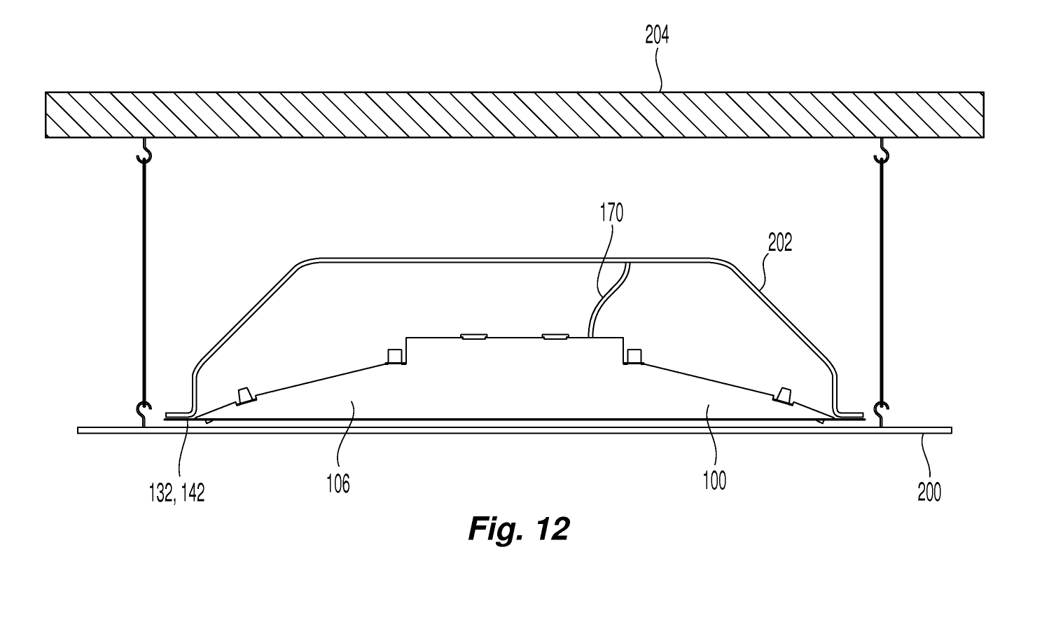

As noted above and in conjunction with FIG. 12, the flat surfaces of the interlocking frame members are resting on the ceiling grid 200 and no components of the retrofit kit 100 have been fixedly attached to the existing troffer lighting fixture 202. Rather, in some instances, the troffer lighting fixture 202 may also be floating within the opening in the ceiling. If the troffer lighting fixture 202 is floating within the ceiling, it may be placed on the first flat surfaces 132 and the outside flat surfaces 142 to help retain the assembled retrofit kit 100 within the opening. Given the sleek nature of the retrofit kit 100, the retrofit kit 100 can be used with most, if not all, pre-installed troffer lighting fixtures. Also, since the front side of the assembled retrofit kit 100 (the flat surfaces 132,142) are disposed on the ceiling grid, the location of the lamps 118 is always at a constant distance from the opening in the ceiling grid. Preferably, the distance from the plane be in which the lamps 118 are positioned to the front of the assembled retrofit kit 100 (plane A) is about 2 inches. See FIG. 6.

While not necessary for operation of the retrofit kit 100, regulations require that the assembled retrofit kit 100 be attached to the existing troffer lighting fixture 202 or to another portion of the ceiling 204. Thus, a flexible member 170 is connected to the assembled retrofit kit 100 and the existing proper lighting fixture 202 and/or the ceiling 204. See FIG. 12. Preferably, the flexible member 117 is airplane wire, but may be of any up for free material to prevent the assembled and installed retrofit kit 100 from falling out of the ceiling in the event of some unforeseen event.

Alternative embodiment of as assembled retrofit kit 100′ is illustrated in FIG. 13. In this embodiment, retrofit kit 100′ is similar to the retrofit kit 100 but the openings 122 for the HVAC system are not present in the side interlocking frame members. Additionally, the side interlocking frame members 102′,104′ are stepped to help reflect the light downward.

It will be apparent to those skilled in the art that various modifications and variations can be made to the present invention without departing from the spirit and scope of the invention. Thus, it is intended that the present invention cover the modifications and variations of this invention provided they come within the scope of the appended claims and their equivalents.

We claim:

1. A retrofit kit for retrofitting an existing troffer lighting fixture having four side walls defining a recessed cavity, the retrofit kit comprising:
a plurality of interlocking frame members that are configured to interconnect with one another to form a rectangular shell with an open face pointing downwards;
a reflector configured to interconnect with respective ones of the plurality of interlocking frame members; and
a lens configured to interconnect with the reflector;
wherein each of the plurality interconnecting frame members comprise a bottom extent and an angled body portion such that the rectangular shell may be formed by the interconnecting frame members and such that the rectangular shell fits within at least a portion of the recessed cavity of the existing troffer lighting fixture when assembled.

2. The retrofit kit according to claim 1, wherein the reflector engages at least a portion of all of the interlocking frame members.

3. The retrofit kit according to claim 1, wherein the assembled frame members rest on a ceiling member and the existing troffer lighting fixture lies on a portion of the assembled frame members.

4. The retrofit kit according to claim 1, wherein the assembled retrofit kit is connected to the existing troffer lighting fixture by a flexible member.

5. The retrofit kit according to claim 1, further comprising sockets that receive lamps, the sockets being connected to at least two of the frame members, the sockets lying in a first plane and the ceiling member lying in a second plane, the first plane and the second plane being parallel to one another and offset from one another by about 2 inches.

6. The retrofit kit according to claim 1, wherein the first plane and the second plane are offset by less than 2 inches.

7. The retrofit kit according to claim 1, wherein the lens comprises two lenses.

8. The retrofit kit according to claim 1, wherein at least one of the frame members has openings therein to allow for air to flow therethrough.

9. A retrofit kit for retrofitting an existing troffer lighting fixture having four side walls defining a recessed cavity, the retrofit kit comprising:
two end frame members, the frame members having bottom surface;
two elongated side frame members, the two elongated side frame members having a bottom surface and attachable to the two end frame members to make a generally rectangular frame;
a reflector attachable at least a portion of each of the two end frame members and engaging at least a portion of the two side frame members; and
a lens attachable to the two elongated side frame members;
the bottom surfaces of the elongated side frame members and the end frame members lying in a first plane when connected to one another, the frame members lying on a ceiling member and extending at least partially into the recessed cavity of the existing troffer lighting fixture.

10. The retrofit kit according to claim 9, further comprising a lens holder, the lens holder engaging the two elongated side frame members and the lens, the lens holder disposed below the lens when installed.

11. The retrofit kit according to claim 9, wherein the existing troffer lighting fixture rests on at least a portion of the bottom surfaces of the elongated side frame members and the end frame members between the ceiling member and existing troffer lighting fixture when installed.

12. The retrofit kit according to claim 9, further comprising at least two sockets to receive at least one lamp, a first of the at least two sockets attachable to a first of the two end frame members, the other of the at least two sockets attachable to the other of the two end frame members, the at least two sockets lying in a second plane, the second plane offset from the first plane by about 2 inches.

13. The retrofit kit according to claim 9, wherein the end frame members have tabs extending therefrom and the elongated side frame members having corresponding openings to receive the tabs of the end frame members to attach the frame members to one another.

14. The retrofit kit according to claim 9, wherein each of the two end frame members have two reflector tabs and the reflector has two slots at either end, the reflector tabs and slots cooperating to hold the reflector relative to the two end frame members.

15. The retrofit kit according to claim 9, further comprising a flexible holding member to secure the assembled retrofit kit to the existing troffer lighting fixture.

16. A retrofit light assembly for an existing troffer lighting fixture having four side walls defining a recessed cavity, the retrofit light assembly comprising:
two end frame members, the frame members having bottom surface;
two elongated side frame members, the two elongated side frame members having a bottom surface and attached to the two end frame members to make a generally rectangular frame;
a reflector attached to at least a portion of each of the two end frame members and engaging at least a portion of the two side frame members; and
a lens engaging the two elongated side frame members,
wherein the bottom surfaces of the elongated side frame members and the end frame members lie in a first plane, the frame members lying on a ceiling member and extending at least partially into the recessed cavity of the existing troffer lighting fixture.

17. The retrofit light assembly according to claim 16, wherein at least one of the two elongated side frame members has openings therein to allow for air to flow therethrough.
